(19) United States
(12) Patent Application Publication
(10) Pub. No.: US 2023/0276734 A1
(43) Pub. Date: Sep. 7, 2023

(54) SYSTEMS AND METHODS FOR PROCESSING YIELD MONITOR DATA

(71) Applicant: J.R. Simplot Company, Boise, ID (US)

(72) Inventors: Lloyd Michael Griffel, Boise, ID (US); Jesse Fielding Lovitt, Eagle, ID (US)

(73) Assignee: J.R. Simplot Company, Boise, ID (US)

(21) Appl. No.: 18/115,672

(22) Filed: Feb. 28, 2023

Related U.S. Application Data
(60) Provisional application No. 63/315,443, filed on Mar. 1, 2022.

(51) Int. Cl. A01D 41/127; A01G 7/00

(52) U.S. Cl. CPC A01D 41/1271; A01G 7/00; A01G 25/00

(57) ABSTRACT

A method for determining crop yield may include receiving yield data, associated respectively with a plurality of harvester machines. The method may further include determining a primary harvester machine, where the primary harvester machine is associated with a largest total harvested area of the plurality of total harvested areas. The method may also include determining a plurality of adjacent harvested areas associated, respectively, with each of the plurality of harvester machines, other than the primary harvester machine, and determining a secondary harvester machine, where the secondary harvester machine is associated with a largest adjacent harvested area of the plurality of adjacent harvested areas. The method may include adjusting a yield measurement associated with the secondary harvester machine using yield measurements associated with the primary harvester machine and generating calibrated yield data including the adjusted yield measurements.

### CROSS-REFERENCE TO RELATED APPLICATIONS

This application claims the benefit of U.S. Provisional Patent Application No. 63/315,443, filed Mar. 1, 2022, and entitled “Systems and Methods for Processing Yield Monitor Data,” the contents of which are incorporated by reference herein in their entirety.

### FIELD OF THE DISCLOSURE

This disclosure is generally related to the field of processing yield monitor data and, in particular, to systems and methods to process yield monitor data captured from harvesters for agricultural data science applications.

### BACKGROUND

High-resolution spatiotemporal yield monitor data may be widely available on various crop harvesting equipment. Yield monitor sensors, such as impact plates associated with grain combines and onboard weight scale systems associated with bulk harvesters, such as those used to harvest potatoes and sugar beets may generate yield measurements. These systems may also incorporate global positioning system (GPS) data, which may be combined with the yield measurements, to produce and log spatially associated yield measurements.

However, these data have been of limited value for agricultural data science applications due to multiple sources of error and deficiencies when computing at an industrial scale. One example of known methods that attempt to mitigate errors in yield maps can be found in Sudduth, K. A., Drummond, S. T., & Myers, D. B. (2012). Yield Editor 2.0: Software for automated removal of yield map errors. In 2012 Dallas, Tex., Jul. 29-Aug. 1, 2012 (p. 1). American Society of Agricultural and Biological Engineers, which is incorporated herein by reference.

Despite error mitigation efforts, some sources of data error may persist in known yield measurement systems. As one example, in multi-harvester applications, yield monitor systems may differ from harvester-to-harvester. This may result in a need to calibrate raw yield measurements between the harvesters. Other disadvantages may exist.

### SUMMARY

Disclosed are systems and methods for processing yield monitoring data that may overcome at least one of the shortcomings described above. In an embodiment, a method may include applying error detection algorithms to a set of raw yield data to form a set of corrected yield data, also referred to herein as intelligent yield data. The algorithms may include an overlap analysis, an operation break analysis, an outlier detection analysis, and a machine-to-machine calibration. An embodiment for machine-to-machine calibration is described below.

In an embodiment, a method for determining crop yield having machine-to-machine calibration includes receiving yield data at a computing device. The yield data includes a plurality of yield measurements associated, respectively, with a plurality of harvester machines. The method further includes determining a plurality of total harvested areas associated, respectively, with each of the plurality of harvester machines. The method also includes determining a primary harvester machine, where the primary harvester machine is associated with a largest total harvested area of the plurality of total harvested areas. The method includes determining a plurality of adjacent harvested areas associated, respectively, with each of the plurality of harvester machines, other than the primary harvester machine, where each of the plurality of adjacent harvested areas is adjacent to the largest total harvested area. The method further includes determining a secondary harvester machine, where the secondary harvester machine is associated with a largest adjacent harvested area of the plurality of adjacent harvested areas. The method also includes adjusting a yield measurement associated with the secondary harvester machine using yield measurements associated with the primary harvester machine. The method includes generating calibrated yield data comprising at least the yield measurement associated with the primary harvester machine and the adjusted yield measurement associated with the secondary harvester machine, where the calibrated yield data is usable across multiple platforms for harvest data analysis.

A use case for the described embodiments involved spatially isolating calibrated intelligent yield data to quantify yield differences among varying management zones or experimental agronomic plots. In an embodiment, the method includes making an agricultural-related decision based on the calibrated yield data. For example, the method may include supporting subfield yield targets to drive nutrient or seed recommendations based at least partially on the calibrated yield data, constructing solid-set irrigation systems in portions of a field selected based at least partially on the calibrated yield data. As another example, the method may include planting a cover crop in portions of a field selected based at least partially on the calibrated yield data. As another example, the method may include selecting a fertilizer rate based at least partially on the calibrated yield data.

In some embodiments, the plurality of harvester machines includes more than two harvester machines, and the method includes, after adjusting the yield measurement associated with the secondary harvester machine, determining a primary harvester system comprising the primary harvester machine and the secondary harvester machine. The system total harvested area is equal to the largest total harvested area and the total harvested area associated with the secondary harvester machine. In some embodiments, the method includes determining a new plurality of adjacent harvested areas associate, respectively, with each of the plurality of harvester machines, other than those of the primary harvester system, where each of the new plurality of adjacent harvested areas is adjacent to the system total harvested area. In some embodiments, the method includes determining a new secondary harvester machine, where the new secondary harvester machine is associated with a new largest adjacent harvested area of the new plurality of adjacent harvested areas and adjusting a yield measurement associated with the new secondary harvester machine using yield measurements associate with the primary harvester system, where the calibrated yield data includes the yield measurement associated with the primary harvester machine and a plurality of adjusted yield measurements.

In some embodiments, the method includes iterating the steps of determining a new primary harvester system, determining a new plurality of adjacent harvested areas, determining a new secondary harvester machine, and calibrating a yield measurement associated with the new second harvester machine until the yield measurements of all the plurality of harvester machines, except the primary harvester machine, have been adjusted.

In some embodiments, the method includes determining a first global yield mean of the plurality of yield measurements prior to adjusting the yield measurement associate with the secondary harvest machine and adjusting the calibrated yield data using the first global yield mean. In some embodiments, adjusting the calibrated yield data using the first global yield mean includes determining a second global yield mean of the yield measurement associated with the primary harvester machine and the plurality of calibrated yield measurements, and scaling the yield measurement associated with the primary harvester machine and the plurality of calibrated yield measurements by a ratio of the first global yield mean to the second global yield mean.

In some embodiments, adjusting the yield measurement associated with the secondary harvester machine using the yield measurements associated with the primary harvester machine includes scaling the yield measurements associated with the secondary harvester machine to minimize a difference between adjacent yield measurements associated, respectively, with the largest total harvested area and the largest adjacent harvested area.

In some embodiments, the method includes, before determining a plurality of total harvested areas associated, respectively, with each of the plurality of harvester machines, removing partial measurements from the yield measurements that do not correspond to a full swath of a harvester machine. In some embodiments, the method includes, before determining a plurality of total harvested areas associated, respectively, with each of the plurality of harvester machines, marking temporally contiguous instances of yield measurements, where the plurality of yield measurements is associated, respectively, with a set of polygons, and where the total harvested areas associated with each of the plurality of harvester machines are determined based on the set of polygons.

In some embodiments, the method includes removing polygons associated with temporal segment endpoints from the set of polygons. In some embodiments, the method includes removing polygons associated with speed outliers from the set of polygons. In some embodiments, the method includes removing polygons associated with yield outliers from the set of polygons. In some embodiments, the method includes determining whether each polygon of the set of polygons is a valid polygon, removing invalid polygons from the set of polygons, calculating an amount that each polygon of the set of polygons overlaps others of the set of polygons, and removing overlapping polygons from the set of polygons when the overlapping polygons overlap with others of the set of polygons by a threshold amount of area, where the total harvested areas associated with each of the plurality of harvester machines are determined based on the set of polygons.

In some embodiments, the method includes, for each of the set of polygons, determining a neighborhood ratio factor based on adjacent polygons associated with a different pass of a harvester machine and removing polygons having a neighborhood ratio factor that exceeds a threshold from the set of polygons. In some embodiments, each yield measurement of the plurality of yield measurements is obtained by one or more yield monitor sensors at each of the plurality of harvester machines and the one or more yield monitor sensors includes an impact plate, a weight scale system, a camera, or a combination thereof.

In an embodiment, a system includes a processor and a memory. The memory stores instructions that, when executed by the processor, cause the processor to receive yield data, the yield data comprising a plurality of yield measurements associated, respectively, with a plurality of harvester machines. The instructions further cause the processor to determine a plurality of total harvested areas associated, respectively, with each of the plurality of harvester machines. The instructions also cause the processor to determine a primary harvester machine, where the primary harvester machine is associated with a largest total harvested area of the plurality of total harvested areas. The instructions cause the processor to determine a plurality of adjacent harvested areas associated, respectively, with each of the plurality of harvester machines, other than the primary harvester machine, where each of the plurality of adjacent harvested areas is adjacent to the largest total harvested area. The instructions further cause the processor to determine a secondary harvester machine, wherein the secondary harvester machine is associated with a largest adjacent harvested area of the plurality of adjacent harvested areas. The instructions also cause the processor to adjust a yield measurement associated with the secondary harvester machine using yield measurements associated with the primary harvester machine. The instructions cause the processor to generate calibrated yield data comprising at least the yield measurement associated with the primary harvester machine and the adjusted yield measurement associated with the secondary harvester machine, where the calibrated yield data is usable across multiple platforms for harvest data analysis.

In some embodiments, the plurality of harvester machines includes more than two harvester machines, and the instructions cause the processor to, after adjusting the yield measurement associated with the secondary harvester machine, determine a primary harvester system comprising the primary harvester machine and the secondary harvester machine, where a system total harvested area is equal to the largest total harvested area and the total harvested area associated with the secondary harvester machine. In some embodiments, the instructions cause the processor to determine a new plurality of adjacent harvested areas associate, respectively, with each of the plurality of harvester machines, other than those of the primary harvester system, where the new plurality of adjacent harvested areas are adjacent to the system total harvested area. In some embodiments, the instructions cause the processor to determine a new secondary harvester machine, where the new secondary harvester machine is associated with a new largest adjacent harvested area of the new plurality of adjacent harvested areas. In some embodiments, the instructions cause the processor to adjust a yield measurement associated with the new secondary harvester machine using yield measurements associate with the primary harvester system, where the calibrated yield data includes the yield measurement associated with the primary harvester machine and a plurality of adjusted yield measurements.

In some embodiments, the instructions cause the processor to iterate the steps of determining a new primary harvester system, determining a new plurality of adjacent harvested areas, determining a new secondary harvester machine, and calibrating a yield measurement associated with the new second harvester machine until the yield measurements of all the plurality of harvester machines, except the primary harvester machine, have been adjusted.

In some embodiments, the instructions cause the processor to determine a first global yield mean of the plurality of yield measurements prior to adjusting the yield measurement associate with the secondary harvest machine and adjust the calibrated yield data using the first global yield mean. In some embodiments, the plurality of yield measurements is associated, respectively, with a set of polygons, where the total harvested areas associated with each of the plurality of harvester machines are determined based on the set of polygons, and where the instructions further cause the processor to, for each of the set of polygons, determine a neighborhood ratio factor based on adjacent polygons associated with a different pass of a harvester machine and remove polygons having a neighborhood ratio factor that exceeds a threshold from the set of polygons.

### BRIEF DESCRIPTION OF THE DRAWINGS

FIG. 1 is a diagram illustrating harvester overlap and its effect on yield measurement.

FIG. 2 is a diagram illustrating an operational break occurring intermittently during a harvester path and its effect on yield measurement.

FIG. 3 is a diagram illustrating an operation break caused by time-delays in yield monitoring sensors and its effect on yield measurement.

FIG. 4 is a flow diagram illustrating an embodiment of a method for processing yield monitor data.

FIG. 5 is a chart depicting raw yield data that is uncorrected.

FIG. 6 is a chart depicting yield data that has been corrected using an embodiment of a method for processing yield monitor data.

FIG. 7 is a block diagram depicting an embodiment of a system for collecting and processing yield monitor data.

FIG. 8 is a block diagram depicting an embodiment of raw yield data.

FIG. 9 is a flow chart depicting an embodiment of a method for processing yield monitor data.

FIG. 10 is a diagram depicting harvest areas for a multi-harvester system.

FIG. 11 is a flow chart depicting a method for determining crop yield in a multi-harvester system.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

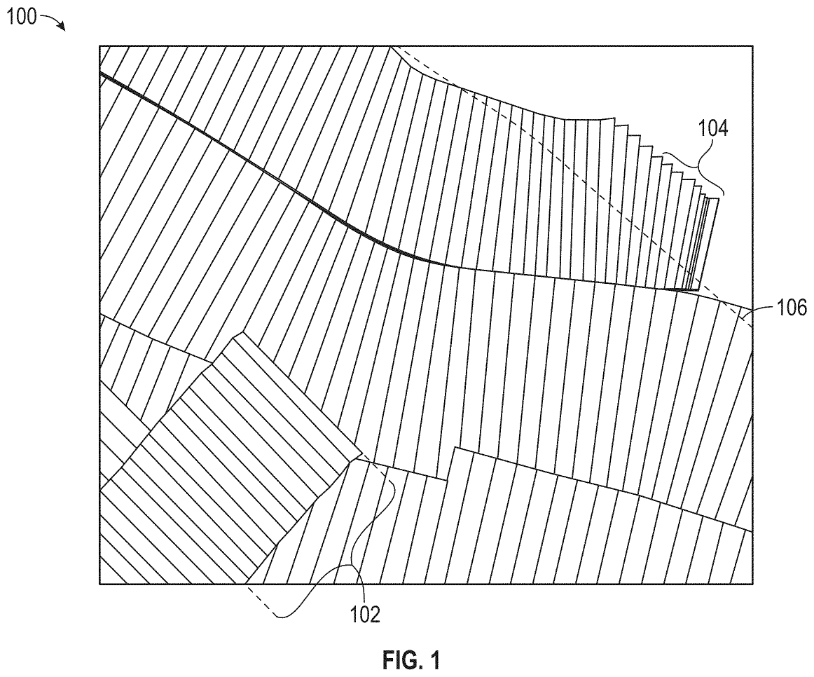

In general, crop yield measurements may be determined by dividing harvest areas into polygons and determining a yield for each polygon. The yield may be based on an estimated flow of harvested material for each polygon. The disclosed systems and methods may help overcome errors that may occur in crop yield measurements. These errors may result from several sources, such as partial coverages during harvest (for example, as the harvester is making passes back and forth across the field, the full swath width of the harvester may not be used and instead may be overlapped with a previously harvested area), invalid polygons, overlapping polygons, temporal segment endpoints, speed outliers, yield outliers, lack of machine-to-machine calibration, harvest opening errors, other types of errors, or combinations thereof. These errors can corrupt further data analysis. Polygons associated with errors can be removed from the dataset to ensure valid data is used for data analysis. FIGS. 1-3 depict some examples of these sources of errors.

Referring to FIG. 1, some examples of harvester overlap are depicted. FIG. 1 depicts a harvester path as a series of polygons 100. In some cases, the polygons 100 may overlap with other polygons as shown at 102. This overlap may introduce errors into crop yield measurements. Overlap may occur in several different scenarios. By way of example, a harvester may make a first pass around the edges of a field to cut a header and then may run subsequent passes back and forth across the field, with turns taking place in the header. As the harvester passes into the header, the degree of overlap with the measurements from the first pass is increased. FIG. 1 also depicts partial coverage errors 104. These partial coverage errors may occur as a result of a portion of a harvester crossing a boundary 106 of a field. Sensors may fail to detect or properly measure yield for a portion of a harvester header when the boundary 106 is crossed. Both instances may result in errors in crop yield measurements.

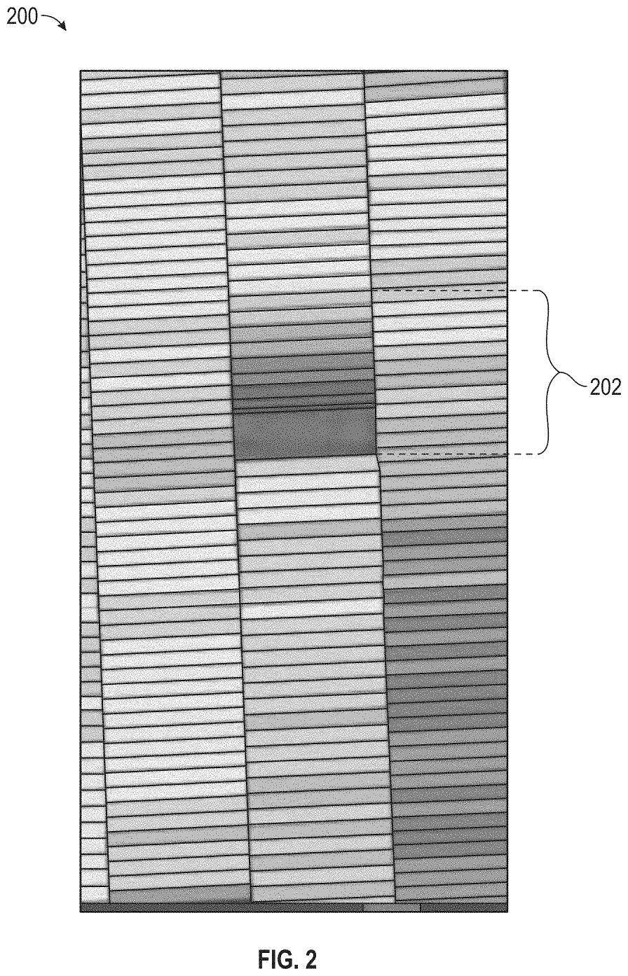

FIG. 2 shows an example of an operational break error 202 occurring intermittently during a harvester path 200. In FIG. 2, each polygon may be coded to show logged yield values while harvesting. The darker polygons at the operational break 202 may show low or zero yield. The operational break error 202 can be caused each time the harvester stops (e.g., pauses to allow a hopper truck to reposition) or when the feed line is plugged. In some instances, intermittent operational breaks can occur when a connection (e.g., wired or wireless) between the yield monitor sensor and a controller receiving the measurements is temporarily interrupted. While stopped, the harvester may continue to run belts carrying the harvested material. When the harvester starts again, it may take some time for harvest material to travel to and fill the machine. As a result, after a stop, low or no yield may be recorded even if harvesting is occurring.

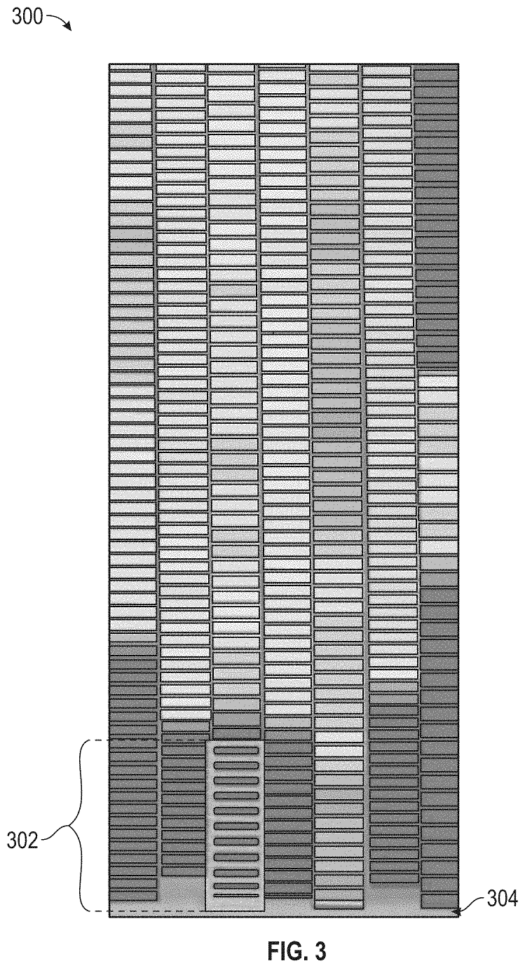

FIG. 3 shows another example of an operational break error 302 in a harvester path 300 caused by similar time-delays in the yield monitor sensor at an edge of a field 304. As with the operational break 202 of FIG. 2, the operational break error 302 may result from a time-delay in recording measurements or the start/stop of a harvester system. As a result, the crop yield measurements of certain yield polygons may incorrectly show zero or low values. The outlined portion of the grid shows an area where the applicable machine logged zero-values adjacent to a break at the end of the field. During harvesting, the yield monitor sensor registers a flow of materials. The yield monitor sensor may register the flow using a weight sensor, such as a weighted conveyor belt, or an impact plate that measures an impact of the flow of materials against the impact plate. By way of example, a weight sensor may be used for potatoes and an impact plate may be used for grain. However, each time the harvester stops, slows down, or lifts up a collector (e.g., to turn around at the end of the pass), the flow of materials is changed. As the operation resumes, the material flow rate (either as a weight or an impact force) may take time to reestablish. As a result, low or no yield may be recorded while the flow rate is altered.

While FIGS. 1-3 illustrated some sources of error that may be introduced into crop yield measurements, these illustrations are not exhaustive, and other sources of error may exist. The systems and methods described herein are broadly applicable and may mitigate or resolve other sources of error that may not be discussed above.

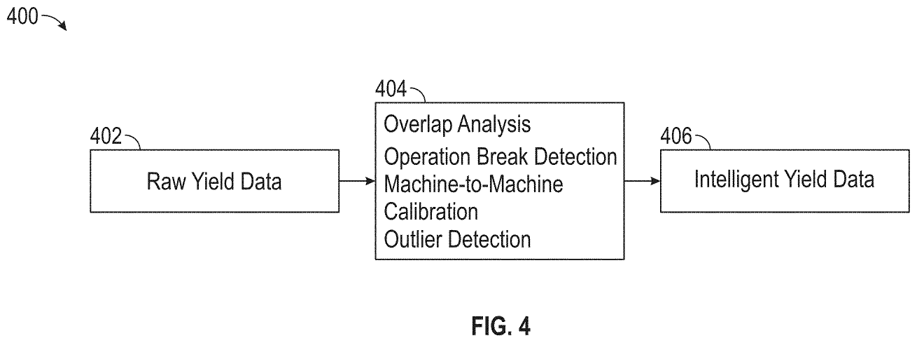

FIG. 4 depicts an embodiment of a method 400 for processing yield monitor data. The method 400 may include receiving raw yield data, at 402. For example, the raw yield data may be received at a computing device as described in more detail herein. The raw yield data may be received from a third-party (e.g., a data aggregator or cloud service) or may be measured directly using yield monitor sensors.

The method 400 may include applying one or more processes 404 to determine corrected yield data 406 (also referred to as “intelligent yield data”) from the raw yield data. The one or more processes 404 may include an overlap analysis, an operational break analysis, a machine-to-machine calibration, an outlier detection analysis, another type of corrective analysis, or combinations thereof. These processes are further described herein.

The overlap analysis may reduce or mitigate overlapping measurements. For example, the raw yield data may include data related to portions of a field that were previously harvested. The harvester may partially pass over those same portions, for example, as a harvester is turning to prepare another pass. Another example of overlap is when a portion of the harvester header overlaps with a previously harvested pass, which may be done to ensure no portion of the field is missed. Portions of the raw yield data that represent significant overlap may be counterproductive for data analysis and may be removed from the dataset.

The operational break analysis may be related to a temporal change between each yield measurement and the one temporally following. For example, if a controller is set to collect yield measurements at 1 Hz (one measurement per second), but the temporal change between yield measurements exceeds one second, then an operational break condition may have occurred. The portion of the yield data related to the break may be excluded. Also, instances temporally adjacent to the break (either upstream or downstream, or both) may be excluded.

The machine-to-machine calibration and outlier detection processes are further described, in more detail, herein. A benefit of applying the one or more processes 404 to the raw yield data is that a more accurate analysis of yield may be determined. This more accurate analysis may be used in multiple practical applications. A first use cases may involve spatially isolating calibrated intelligent yield data to quantify yield differences among varying management zones, experimental agronomic plots, etc. Additionally calibrated yield data could be used to support subfield yield targets driving nutrient/seed recommendations. In another example, the corrected yield data may be used in constructing solid-set irrigation systems in portions of a field selected based at least partially on the corrected yield data. As another example, the corrected yield data may be used in planting a cover crop in portions of a field selected based at least partially on the corrected yield data. Also, the corrected yield data may be used in selecting a fertilizer rate for future crops. Other examples and other advantages may exist.

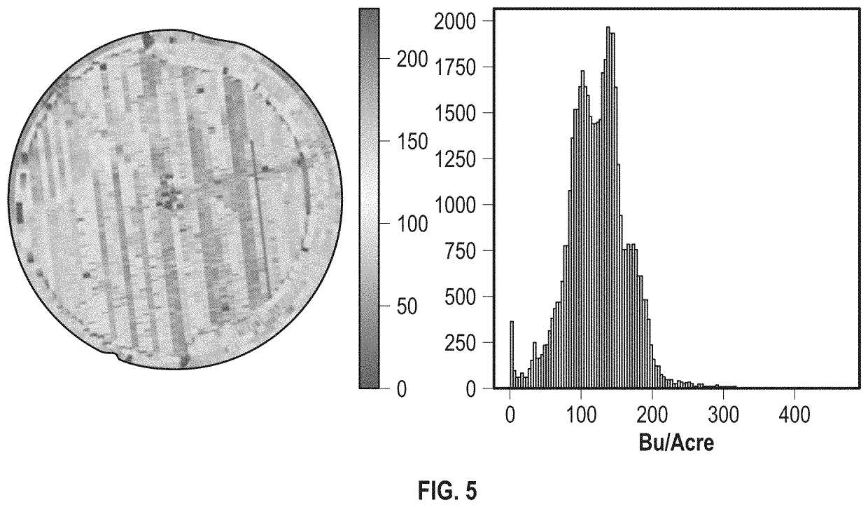

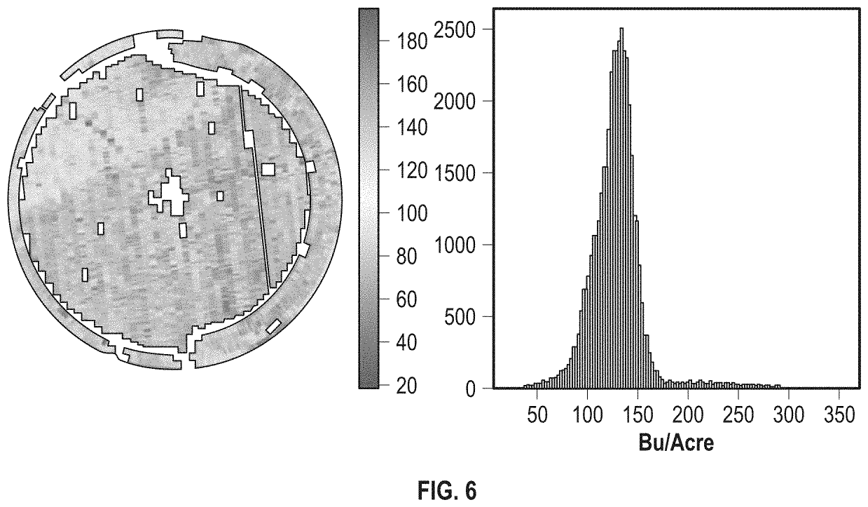

FIG. 5 shows an example of raw yield data represented as a harvest map and a histogram, while FIG. 6 shows an example of corrected yield data, likewise, represented as a harvest map and a histogram. The corrected yield data shown in FIG. 6 may include data that has been processed using overlap analysis, operational break analysis, outlier detection, machine-to-machine calibration, or a combination thereof. As can be seen, from the graphs, the corrected yield data may be cleaner and more consistent than the raw yield data.

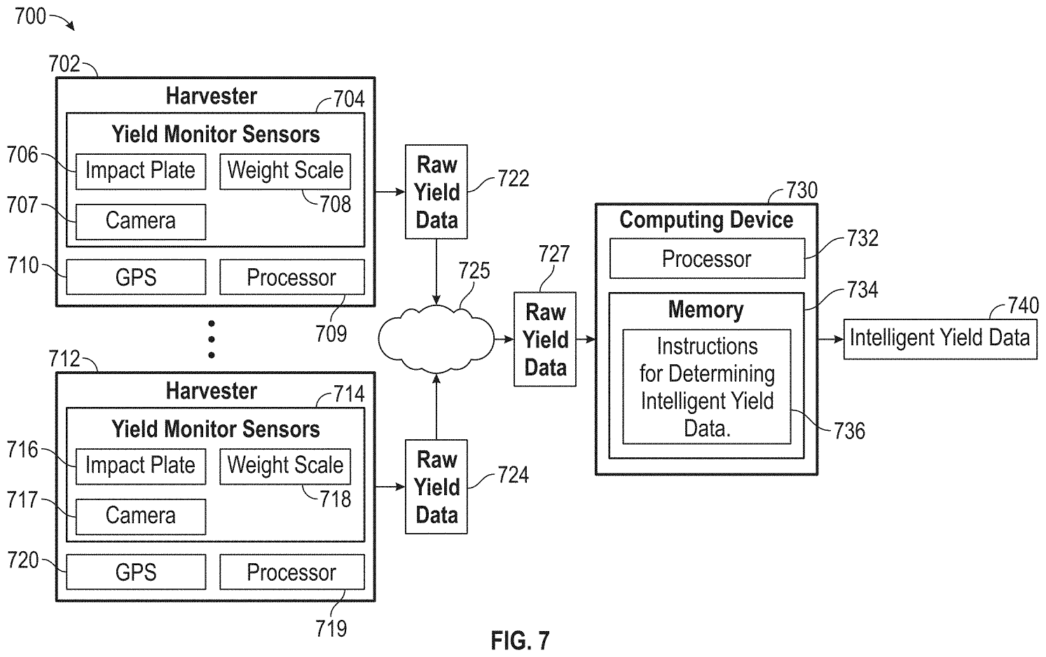

Referring to FIG. 7, a system 700 for generating intelligent yield data 740 is depicted. The system 700 may include multiple harvesters, such as a first harvester 702 and a second harvester 712. As used herein, the term harvester may include grain combines, bulk harvesters, other equipment for harvesting grain, fruit, vegetables, and other agricultural products, or combinations thereof. The system 700 may also include additional harvesters, which have been omitted for clarity.

The first harvester 702 may include yield monitoring sensors 704. As examples, the yield monitoring sensors 704 may include an impact plate 706, a weight scale 708, a camera 707, another type of yield monitoring sensor, or combinations thereof. The harvester 702 may also include a GPS device 710 for determining position information. A processor 709 may be used to collect raw yield data 722 from yield monitor sensors 704 and from the GPS 710 of the first harvester 702.

The yield monitor sensors 704 may register the flow of produce using the weight scale 708, which may be a weighted conveyor belt, or using the impact plate 706 that measures an impact of the flow of materials against the impact plate. By way of example, the weight scale 708 may be better suited for potatoes and the impact plate 706 may be used for grain.

In some embodiments, the camera 707 and the processor 709 may operate with one or more algorithms programmed to estimate the yield of products and compare the estimated yield with the measurement by the other yield monitor sensors 704. If the processor 709. determines that an operational break error has occurred, where the measured yield is below the estimated yield, the estimated yield may be substituted for the measured yield. Further, the processor 709 may be programmed with one or more algorithms to calculate a ratio of product to foreign materials. For example, the processor 709 may calculate a ratio of dirt clods and vines to potatoes to determine a more accurate yield calculation. The ratio may be used to scale the local crop yield measurement.

Likewise, the second harvester 712 may include yield monitoring sensors 714, which may include an impact plate 716, a weight scale 718, a camera 717, another type of yield monitoring sensor, or combinations thereof. The second harvester 712 may also include a GPS device 720 for determining position information and a processor 719, which may be programmed as described with respect to the first harvester 702.

Raw yield data 722, 724 may be transmitted from the harvesters 702, 712 to a cloud network 725, where it may be aggregated into combined raw yield data 727. Once collected and aggregated, the combined raw yield data 727 may be transmitted to and received by a computing device 730. Alternatively, in some embodiments, the raw yield data 722, 724 may be stored in removable memory storage and later transferred individually to the computing device 730. Other methods of collecting the raw yield data 722, 724 from the harvesters 702, 712 may exist.

The computing device 730 may include a processor 732 and memory 734. The processor 732 may include a central processing unit (CPU), a graphical processing unit (GPU), a digital signal processor (DSP), a peripheral interface controller (PIC), another type of microprocessor or microcontroller, and/or combinations thereof. Further, the processor 732 may be implemented using integrated circuits, field-programmable gate arrays (FPGAs), application-specific integrated circuit (ASICs), combinations of logic gate circuitry, other types of digital or analog electrical design components, or combinations thereof. The memory 734 may include memory devices such as random-access memory (RAM), read-only memory (ROM), magnetic disk memory, optical disk memory, flash memory, another type of memory capable of storing data and processor instructions, or the like, or combinations thereof.

The memory 734 may store instructions 736 for determining intelligent yield data 740 as described further herein. For example, the instructions 736 may be readable by the processor 732 to perform any of the operations described herein.

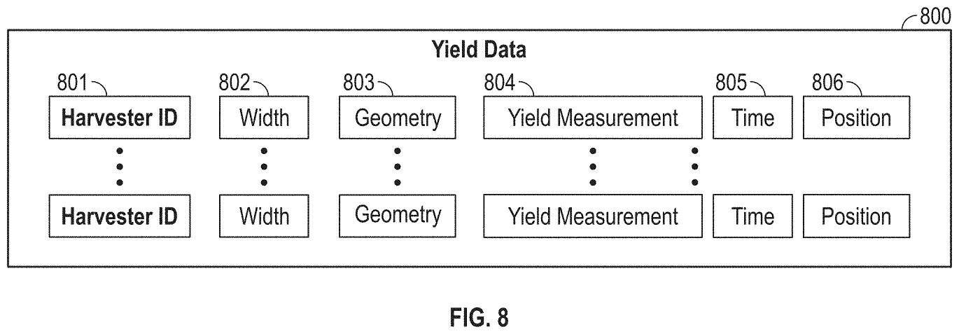

Referring to FIG. 8, an embodiment of raw yield data 800 is depicted. The raw yield data 800 may correspond to the raw yield data 722, 724, 727 of FIG. 7. Data fields included within the raw yield data 800 may include a harvester ID field 801, a width field 802, a geometry field 803, a yield measurement field 804, a time field 805, and a position field 806. These data points may be taken approximately every 1 to 2 seconds by each harvester (e.g., the harvesters 702, 712) such that the yield data 800 includes many entries representing harvest paths taken by each harvester.

The harvester ID field 801 may identify a particular harvester that recorded each entry in the yield data 800. The width field 802 may indicate a width of a header attached to the harvester (or a portion of the header actually used to harvest). The geometry field 803 may include a calculated representation of a polygon associated with a harvested area. Examples of such a polygon may be seen in FIGS. 1-3. The yield measurement field 804 may indicate a yield value associated with the polygon described by the geometry field 803. The time field 805 and the position field 806 may be usable to calculate the geometry field 803 and may be indicative of a time associated with the entry and a GPS position of the harvester that registered the entry. It is noted that other fields, which are not shown, may also be included in the yield data 800. Further, because each entry in the yield data 800 is associated with a polygon, references herein to polygons and removing polygons can be understood at referring to entries in the yield data 800 and removing entries from the yield data 800.

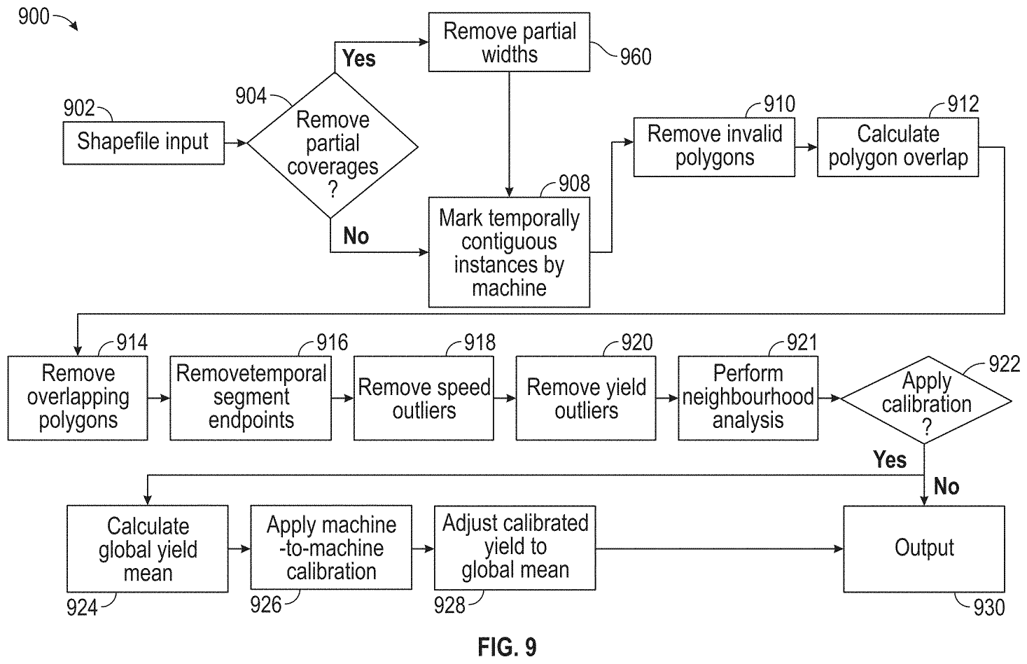

Referring to FIG. 9, an embodiment of a method for processing yield monitor data is depicted. The method 900 may include receiving raw yield data into a processor, at 902. Although FIG. 9 describes the raw yield data as being a shapefile input, other forms of input are possible. As an example, the raw yield data 727 of FIG. 7 may be received at the computing device 730.

Next, the method 900 may include evaluating the raw yield data to determine whether to remove partial coverages, at 904. Partial coverages may exist if the full swath of a harvesting header does not produce harvesting data. For example, this may occur, as shown in FIG. 1, when a harvester is partially outside a field boundary.

If the partial coverages exceed an allowable limit, the method 900 may include removing data corresponding to partial widths from the data set, at 906. As an example, entries from the yield data 800 may be removed when they do not correspond to data taken using a full width of the harvester header. This can be determined using the width field 802 or the geometry field 803.

As explained herein, the raw yield data may comprise data from more than one yield monitor positioned on different harvester machines. The yield data may be marked as temporally contiguous instances by the respective harvesting machine, at 908. For example, the yield data may form a plurality of polygons as determined by the geometry field 803. Some of the polygons may show operational break errors, as described herein. The yield data may be annotated to indicate contiguous strings of polygons that have no operational breaks. In some embodiments, polygons associated with operational breaks may be removed.

The method 900 may include removing polygons that are invalid, at 910. For example, entries from the yield data 800 where the geometry field 803 does not indicate a valid polygon may be removed from the yield data. Further, any entries that lack data, such as the time field 805, the position 806, or other types of data, may be removed from the set.

The method 900 may also include calculating polygon overlap for each polygon in the yield data, at 912. This overlap analysis may evaluate the extent of spatial overlap of two yield polygons measurements. If the overlap exceeds a predetermined value, then the yield measurement for the later measurement may be disregarded or discounted (e.g. removed from the yield data 800). In some embodiments, the threshold of overlap may be 15%, and preferably 5%. It may be desirable to use a lower threshold (e.g., 5%) when a higher degree of accuracy is desired. In some embodiments, a higher threshold (e.g., 15%) may be used to generate visual maps used to identify overall trends of the data.

Next, the polygons that overlap other polygons of the yield data by more than the threshold among may be removed, at 914. For example, the overlapping polygons depicted in FIG. 1, at 102, may be removed from the raw yield data (e.g., the yield data 800).

The method 900 may include removing polygons associated with endpoints of temporal segments of the harvesting machine, at 916. The endpoints may correspond to polygons found at the ends of each of the temporally contiguous instances marked, which were marked at step 908. These polygons may be associated with operational breaks and other inconsistencies as depicted in FIGS. 2 and 3.

The method 900 may include removing speed outliers, at 918, and removing yield outliers, at 920. For example, some polygons may be associated with a speed of the respective harvester that is too high to obtain an accurate yield measurement. In order to ensure the accuracy of the yield data, these outliers may be removed. Likewise, yield outliers, where the measured yield is too high to have plausibly occurred without error are removed.

The method 900 may include performing a neighborhood analysis, at 921. For example, for each of the set of polygons (e.g., the yield data 800), a neighborhood ratio factor may be determined based on adjacent polygons associated with a different pass of a harvester machine. In other words, neighbors that are spatially adjacent, but not temporally adjacent may be compared to form a ratio. Polygons having a neighborhood ratio factor that exceeds a threshold may be removed from the set of polygons.

The reason these neighboring polygons may be removed is to eliminate polygons whose yield measurements may have been corrupted by opening a field. When a field is opened to harvest, a windrower or a harvester may be used, not to harvest, but to move the produce to another row (to be collected at another pass). This can help make room for a parallel truck to be used to collect the produce without causing damage to unharvested crops below it. If a windrower is used, then on the next pass, yield measurements may include, not only the produce from that pass, but also the produce that was moved by the windrower. If a harvester is used, then the harvester may register additional yield, when in fact it is beings used to move the produce rather than harvest. By removing polygons that exhibit a high ratio relative to their neighbors, errors introduced by opening a field in this way can be eliminated from the yield data.

Finally, the yield measurements are scaled and calibrated. The method 900 may include calculating a global yield mean, at 924. Then, the yield measurements of different machines may be calibrated using measurement data from adjacent machines, at 926. Afterward, the yield measurements may be globally scaled, at 928. The yield measurements may be globally scaled to the global mean calculated before the machine-to-machine calibration. These final steps are described further herein.

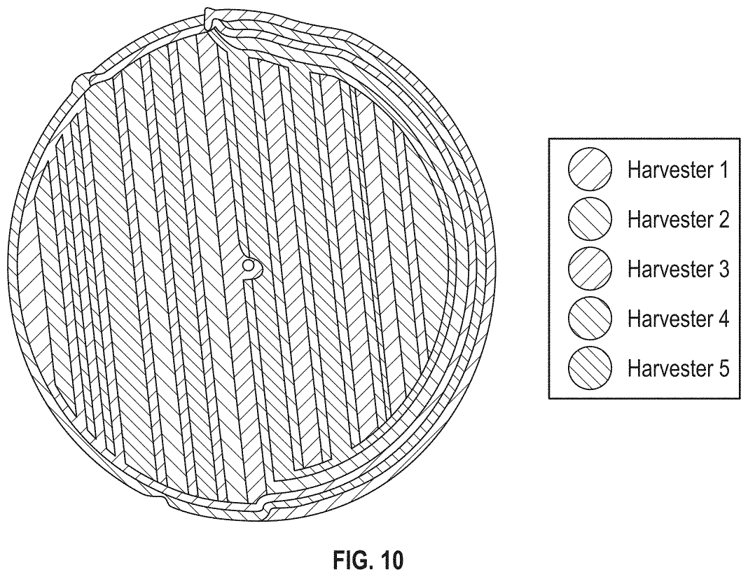

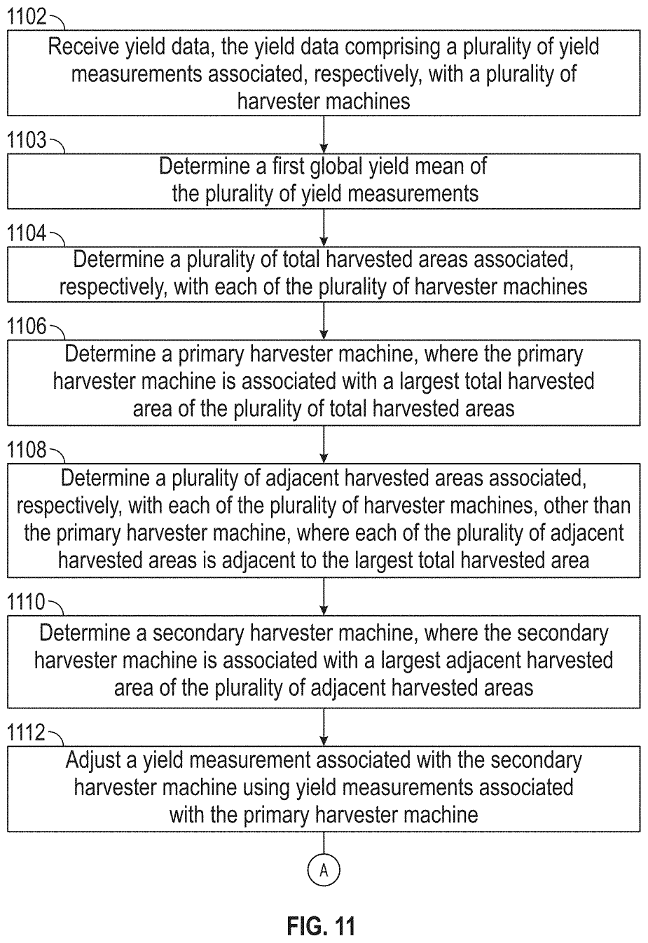

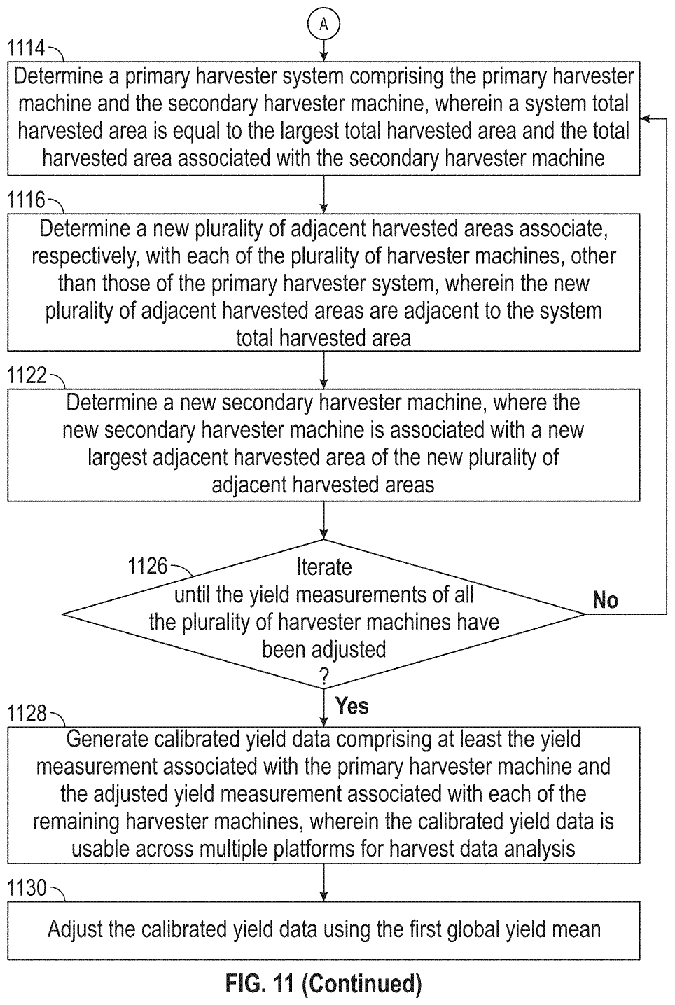

Referring to FIG. 10, an overview of machine-to-machine calibration is provided. Then, in FIG. 11, a more specific method for performing the machine-to-machine calibration is described.

Referring to FIG. 10, machine-to-machine calibration evaluates differences in measured yield values between adjacent machines. First, a primary machine may be identified. The primary machine may be the machine that harvests the most area. The primary machine may be used as a calibration standard for other harvesters. FIG. 10 shows an example of a field that has been harvested using five harvesters. For purposes of discussion, Harvester 2 of FIG. 10 (not drawn to scale) is determined to be the primary machine because it harvested the most area. Next, harvesting profiles of the other machines are evaluated to determine which of the other machines are most spatially adjacent to the primary machine. The most spatially adjacent machine is referred to as the secondary machine. To identify the secondary machine, a harvesting profile for each machine is created by calculating the amount of area harvested that is directly adjacent to the area harvested by the primary machine. For instance, if Harvester 3 had 20 acres that was directly adjacent to Harvester 2 (the primary machine), Harvester 5 had 15 acres that was directly adjacent to Harvester 2, and Harvester 1 had 6 acres that was directly adjacent to Harvester 2, then Harvester 3 would be identified as the secondary machine.

The yield measurements of the secondary machine are then scaled using the yield measurements of the primary machine. For example, the yield measurements of the secondary machine may be scaled by a ratio of a mean yield measurement of the primary machine to a mean yield measurement of the secondary machine to minimize the difference between the mean yield measurements at spatially adjacent sections. The local yield means of the primary machine and of the secondary machine may be calculated where they are spatially adjacent (i.e. where their collection passes are next to each other). The local yield measurements of the secondary machine are expected to be close or equal to the local yield measurements of the primary machine. The differences between the local yield means of the primary machine and of the secondary machine may be used to scale the yield measurements of the secondary machine to minimize those differences.

After the secondary machine has been calibrated using the yield measurements of the primary machine, the process is repeated. The primary machine is reorganized as a combination of the primary machine and the secondary machine, and a new secondary machine is determined based on the machine that is the most spatially adjacent to the reorganized primary machine.

Using the example above, harvesting profiles of Harvester 1, Harvester 4, and Harvester 5 may be calculated to determine the amount of area harvested that is directly adjacent to the area harvested by either Harvester 2 or Harvester 3 (Harvester 2 and Harvester 3 now collectively form the primary machine or system). The harvester with the most harvested area that is directly adjacent to the area harvested by either Harvester 2 or Harvester 3 is determined to be the new secondary machine and its yield measurements are calibrated using the yield measurements of Harvester 2 or Harvester 3.

The process may continue until all the harvesters are calibrated. The first harvester is used as the calibration standard for the harvester that has the most harvested area adjacent to the first harvester. Then those two harvesters, as calibrated, are used as the calibration standard for the harvester that has the most harvested area adjacent to either of those two harvesters. Then those three harvesters, as calibrated, are used as the calibration standard for the harvester that has the most harvested area adjacent to any of those three harvesters. This process is continued until the last harvester is calibrated using all of the other harvesters as its calibration standard.

Once the yield measurements have been calibrated, a global calibration may be applied. All of the yield measurements may be scaled up or down to align with the final yield. For instance, if the final yield was 110% of the sum of all of the corrected yield measurements after machine-to-machine calibration, then a scaling factor of 1.1 may be applied to all of the yield measurements. In some embodiments, the global mean yield calculated before machine-to-machine calibration may be used as the calibration point for the global mean yield after machine-to-machine calibration.

Referring to FIG. 11, a method 1100 for determining crop yield is depicted. The method 1100 may correspond to the machine-to-machine calibration described above. For example, the method 900 may be applied to the yield data, as explained herein, and the method 1100 may correspond to the steps 925, 926, and 928.

The method 1100 may include receiving yield data, the yield data comprising a plurality of yield measurements associated, respectively, with a plurality of harvester machines, at 1102. For example, the computing device 730 may receive the raw yield data 727.

The method 1100 may include determining a first global yield mean of the plurality of yield measurements, at 1103. This global yield mean may be used at a later time to scale each of the yield measurements after machine-to-machine calibration has occurred.

The method 1100 may further include determining a plurality of total harvested areas associated, respectively, with each of the plurality of harvester machines, at 1104. For example, a total area associated with each of the harvesters shown in FIG. 10 may be determined.

The method 1100 may also include determining a primary harvester machine, wherein the primary harvester machine is associated with a largest total harvested area of the plurality of total harvested areas, at 1106. In the example of FIG. 10, Harvester 2 was determined to be the primary harvester machine.

The method 1100 may include determining a plurality of adjacent harvested areas associated, respectively, with each of the plurality of harvester machines, other than the primary harvester machine, wherein each of the plurality of adjacent harvested areas is adjacent to the largest total harvested area, at 1108.

The method 1100 may further include determining a secondary harvester machine, wherein the secondary harvester machine is associated with a largest adjacent harvested area of the plurality of adjacent harvested areas, at 1110. In the example of FIG. 10, this was Harvester 3.

The method 1100 may also include adjusting a yield measurement associated with the secondary harvester machine using yield measurements associated with the primary harvester machine, at 1112. Adjusting the yield measurement associated with the secondary harvester machine using the yield measurements associated with the primary harvester machine may include scaling the yield measurements associated with the secondary harvester machine to minimize a difference between adjacent yield measurements associated, respectively, with the largest total harvested area and the largest adjacent harvested area.

The method 1100 may include, after adjusting the yield measurement associated with the secondary harvester machine, determining a primary harvester system comprising the primary harvester machine and the secondary harvester machine, wherein a system total harvested area is equal to the largest total harvested area and the total harvested area associated with the secondary harvester machine, at 1114.

The method 1100 may further include determining a new plurality of adjacent harvested areas associate, respectively, with each of the plurality of harvester machines, other than those of the primary harvester system, wherein the new plurality of adjacent harvested areas are adjacent to the system total harvested area, at 1116.

The method 1100 may also include determining a new secondary harvester machine, wherein the new secondary harvester machine is associated with a new largest adjacent harvested area of the new plurality of adjacent harvested areas, at 1118.

The method 1100 may also include adjusting a yield measurement associated with the new secondary harvester machine using yield measurements associate with the primary harvester system, wherein the calibrated yield data includes the yield measurement associated with the primary harvester machine and a plurality of adjusted yield measurements, at 1124.

The method 1100 may include iterating the steps of determining a new primary harvester system, determining a new plurality of adjacent harvested areas, determining a new secondary harvester machine, and calibrating a yield measurement associated with the new second harvester machine until the yield measurements of all the plurality of harvester machines, except the primary harvester machine, have been adjusted, at 1126.

The method 1100 may include generating calibrated yield data comprising at least the yield measurement associated with the primary harvester machine and the adjusted yield measurement associated with each of the remaining harvester machines, wherein the calibrated yield data is usable across multiple platforms for harvest data analysis, at 1128.

The method 1100 may further include adjusting the calibrated yield data using the first global yield mean, at 1130. Adjusting the calibrated yield data using the first global yield mean may include determining a second global yield mean of the yield measurement associated with the primary harvester machine and the plurality of calibrated yield measurements and scaling the yield measurement associated with the primary harvester machine and the plurality of calibrated yield measurements by a ratio of the first global yield mean to the second global yield mean.

Several benefits of the method 1100 may exist. For example, the calibrated yield data, also referred to as intelligent yield data, may be more desirable for data analysis because polygons associated with erroneous data have been removed, or otherwise marked. Further, the calibrated yield data may be usable with multiple platforms for data analysis than the raw yield data. An immediate use case may involve spatially isolating calibrated intelligent yield data to quantify yield differences among varying management zones, experimental agronomic plots, etc. Additionally calibrated yield data could be used to support subfield yield targets driving nutrient/seed recommendations. The calibrated yield data may be usable in other practical applications such as constructing solid-set irrigation systems in portions of a field selected based at least partially on the calibrated yield data, planting a cover crop in portions of a field selected based at least partially on the calibrated yield data, selecting a fertilizer rate based at least partially on the calibrated yield data. Other applications are possible.

Although various embodiments have been shown and described, the present disclosure is not so limited and will be understood to include all such modifications and variations as would be apparent to one skilled in the art.

What is claimed is:

1. A method for determining crop yield, the method comprising:
receiving yield data, the yield data comprising a plurality of yield measurements associated, respectively, with a plurality of harvester machines;
determining a plurality of total harvested areas associated, respectively, with each of the plurality of harvester machines;
determining a primary harvester machine, wherein the primary harvester machine is associated with a largest total harvested area of the plurality of total harvested areas;
determining a plurality of adjacent harvested areas associated, respectively, with each of the plurality of harvester machines, other than the primary harvester machine, wherein each of the plurality of adjacent harvested areas is adjacent to the largest total harvested area;
determining a secondary harvester machine, wherein the secondary harvester machine is associated with a largest adjacent harvested area of the plurality of adjacent harvested areas;
adjusting a yield measurement associated with the secondary harvester machine using yield measurements associated with the primary harvester machine;
generating calibrated yield data comprising at least the yield measurement associated with the primary harvester machine and the adjusted yield measurement associated with the secondary harvester machine, wherein the calibrated yield data is usable across multiple platforms for harvest data analysis.

2. The method of claim 1, further comprising performing at least one of:
constructing solid-set irrigation systems in portions of a field selected based at least partially on the calibrated yield data;
planting a cover crop in portions of a field selected based at least partially on the calibrated yield data;
selecting a fertilizer rate based at least partially on the calibrated yield data; and
supporting a subfield yield target driving nutrient or seed determinations based at least partially on the calibrated yield data.

3. The method of claim 1, wherein the plurality of harvester machines includes more than two harvester machines, and further comprising:
after adjusting the yield measurement associated with the secondary harvester machine, determining a primary harvester system comprising the primary harvester machine and the secondary harvester machine, wherein a system total harvested area is equal to the largest total harvested area and the total harvested area associated with the secondary harvester machine;
determining a new plurality of adjacent harvested areas associate, respectively, with each of the plurality of harvester machines, other than those of the primary harvester system, wherein each of the new plurality of adjacent harvested areas is adjacent to the system total harvested area;
determining a new secondary harvester machine, wherein the new secondary harvester machine is associated with a new largest adjacent harvested area of the new plurality of adjacent harvested areas; and
adjusting a yield measurement associated with the new secondary harvester machine using yield measurements associate with the primary harvester system, wherein the calibrated yield data includes the yield measurement associated with the primary harvester machine and a plurality of adjusted yield measurements.

4. The method of claim 2, further comprising iterating the steps of determining a new primary harvester system, determining a new plurality of adjacent harvested areas, determining a new secondary harvester machine, and calibrating a yield measurement associated with the new second harvester machine until the yield measurements of all the plurality of harvester machines, except the primary harvester machine, have been adjusted.

5. The method of claim 3, further comprising:
determining a first global yield mean of the plurality of yield measurements prior to adjusting the yield measurement associate with the secondary harvest machine; and
adjusting the calibrated yield data using the first global yield mean.

6. The method of claim 4, wherein adjusting the calibrated yield data using the first global yield mean comprises:
determining a second global yield mean of the yield measurement associated with the primary harvester machine and the plurality of calibrated yield measurements; and
scaling the yield measurement associated with the primary harvester machine and the plurality of calibrated yield measurements by a ratio of the first global yield mean to the second global yield mean.

7. The method of claim 1, wherein adjusting the yield measurement associated with the secondary harvester machine using the yield measurements associated with the primary harvester machine comprises scaling the yield measurements associated with the secondary harvester machine to minimize a difference between adjacent yield measurements associated, respectively, with the largest total harvested area and the largest adjacent harvested area.

8. The method of claim 1, further comprising, before determining a plurality of total harvested areas associated, respectively, with each of the plurality of harvester machines, removing partial measurements from the yield measurements that do not correspond to a full swath of a harvester machine.

9. The method of claim 1, further comprising, before determining a plurality of total harvested areas associated, respectively, with each of the plurality of harvester machines, marking temporally contiguous instances of yield measurements, wherein the plurality of yield measurements is associated, respectively, with a set of polygons, and wherein the total harvested areas associated with each of the plurality of harvester machines are determined based on the set of polygons.

10. The method of claim 9, further comprising removing polygons associated with temporal segment endpoints from the set of polygons.

11. The method of claim 9, further comprising removing polygons associated with speed outliers from the set of polygons.

12. The method of claim 9, further comprising removing polygons associated with yield outliers from the set of polygons.

13. The method of claim 9;
determining whether each polygon of the set of polygons is a valid polygon;
removing invalid polygons from the set of polygons;
calculating an amount that each polygon of the set of polygons overlaps others of the set of polygons; and
removing overlapping polygons from the set of polygons when the overlapping polygons overlap with others of the set of polygons by a threshold amount of area, wherein the total harvested areas associated with each of the plurality of harvester machines are determined based on the set of polygons.

14. The method of claim 9, further comprising:
for each of the set of polygons, determining a neighborhood ratio factor based on adjacent polygons associated with a different pass of a harvester machine; and
removing polygons having a neighborhood ratio factor that exceeds a threshold from the set of polygons.

15. The method of claim 1, wherein each yield measurement of the plurality of yield measurements is obtained by one or more yield monitor sensors at each of the plurality of harvester machines, wherein the one or more yield monitor sensors includes an impact plate, a weight scale system, or a combination thereof.

16. A system comprising a processor and a memory, wherein the memory stores instructions that, when executed by the processor, cause the processor to:
receive yield data, the yield data comprising a plurality of yield measurements associated, respectively, with a plurality of harvester machines;
determine a plurality of total harvested areas associated, respectively, with each of the plurality of harvester machines;
determine a primary harvester machine, wherein the primary harvester machine is associated with a largest total harvested area of the plurality of total harvested areas;
determine a plurality of adjacent harvested areas associated, respectively, with each of the plurality of harvester machines, other than the primary harvester machine, wherein each of the plurality of adjacent harvested areas is adjacent to the largest total harvested area;
determine a secondary harvester machine, wherein the secondary harvester machine is associated with a largest adjacent harvested area of the plurality of adjacent harvested areas;
adjust a yield measurement associated with the secondary harvester machine using yield measurements associated with the primary harvester machine;
generate calibrated yield data comprising at least the yield measurement associated with the primary harvester machine and the adjusted yield measurement associated with the secondary harvester machine, wherein the calibrated yield data is usable across multiple platforms for harvest data analysis.

17. The system of claim 16, wherein the plurality of harvester machines includes more than two harvester machines, and wherein the instructions further cause the processor to:
after adjusting the yield measurement associated with the secondary harvester machine, determine a primary harvester system comprising the primary harvester machine and the secondary harvester machine, wherein a system total harvested area is equal to the largest total harvested area and the total harvested area associated with the secondary harvester machine;
determine a new plurality of adjacent harvested areas associate, respectively, with each of the plurality of harvester machines, other than those of the primary harvester system, wherein the new plurality of adjacent harvested areas are adjacent to the system total harvested area;
determine a new secondary harvester machine, wherein the new secondary harvester machine is associated with a new largest adjacent harvested area of the new plurality of adjacent harvested areas; and
adjust a yield measurement associated with the new secondary harvester machine using yield measurements associate with the primary harvester system, wherein the calibrated yield data includes the yield measurement associated with the primary harvester machine and a plurality of adjusted yield measurements.

18. The system of claim 17, wherein the instructions further cause the processor to iterate the steps of determining a new primary harvester system, determining a new plurality of adjacent harvested areas, determining a new secondary harvester machine, and calibrating a yield measurement associated with the new second harvester machine until the yield measurements of all the plurality of harvester machines, except the primary harvester machine, have been adjusted.

19. The method of claim 18, wherein the instructions further cause the processor to:
determine a first global yield mean of the plurality of yield measurements prior to adjusting the yield measurement associate with the secondary harvest machine; and
adjust the calibrated yield data using the first global yield mean.

20. The method of claim 16, wherein the plurality of yield measurements is associated, respectively, with a set of polygons, wherein the total harvested areas associated with each of the plurality of harvester machines are determined based on the set of polygons, and wherein the instructions further cause the processor to:
for each of the set of polygons, determine a neighborhood ratio factor based on adjacent polygons associated with a different pass of a harvester machine; and
remove polygons having a neighborhood ratio factor that exceeds a threshold from the set of polygons.
